(19) United States
(12) Patent Application Publication
(10) Pub. No.: US 2005/0252079 A1
(43) Pub. Date: Nov. 17, 2005

(54) Plastic container for collecting rain water

(76) Inventor: Gunter Richter, Altenkirchen (DE)

Correspondence Address: FRIEDRICH KUEFFNER, 317 MADISON AVENUE, SUITE 910, NEW YORK, NY, 10017, US

(21) Appl. No.: 10/524,349

(22) PCT Filed: Aug. 14, 2003
(86) PCT No.: PCT/EP03/09047

§ 371 Date: Feb. 11, 2005

(30) Foreign Application Priority Data
Aug. 14, 2002 (DE) 102 37 299.3

(51) Int. Cl. A01G 9/02

(52) U.S. Cl. 47/79

(57) ABSTRACT

A plastic container for collecting rain water in a cavity (22). The essentially closed upper side is shaped like a trough (16) which is embodied as a carrying surface. The inventive container can be used in gardens since it can be incorporated into the ground like an underground cistern and the upper part thereof can, for example, be planted upon,

[symbol]

The invention concerns a plastic container for collecting rainwater, which has an underside that rests on the ground, a cavity for collecting the rainwater, and an upper side.

A container of this type can be used as a rainwater collection device and is often found in gardens. The use of rain barrels for collecting rainwater is well known. Underground cisterns are used for larger volumes of water. This usually requires extensive excavation work. The installation of a large-volume container in a garden is often seen as undesirable, since it does not have a pleasing appearance and gets in the way due to its large volume.

The objective of the invention is to specify a plastic container for collecting rainwater that can be integrated in a garden in a pleasing way.

This objective is achieved for a container of the aforementioned type by designing the essentially closed upper side as a trough that acts as a bearing surface.

In accordance with the invention, the container is essentially closed at the top and thus acts much like an underground cistern. This means that no leaves or wind-driven debris can get into the collected rainwater in the tank from above. In addition, the upper side has the shape of a trough, which is designed as a bearing surface. For example, the trough can form the bottom of a garden pond, so that the whole container can serve as an attractively designed, decorative element in the garden. The container then has a dual function: it serves both as an above-ground rainwater storage device and as a garden pond that can be nicely integrated in the garden.

In another variant, a flower bed or a small rock garden can be placed in the trough. This variant also combines the practical benefit of rainwater collection with an attractive decorative garden element.

A specific embodiment of the invention is explained below with reference to the drawings.

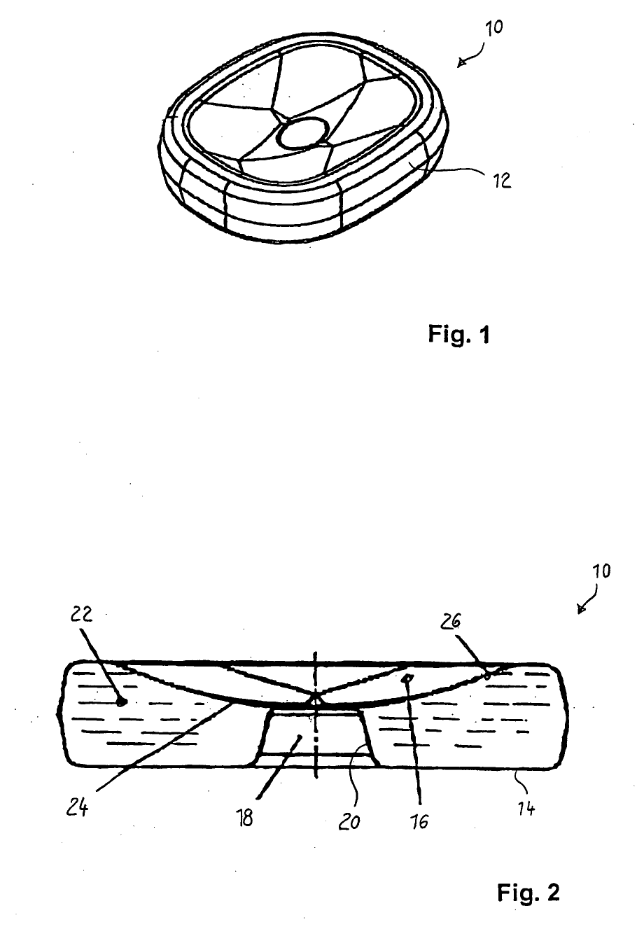

FIG. 1 shows a perspective view of a plastic container from above.

FIG. 2 shows a schematic cross section of the container.

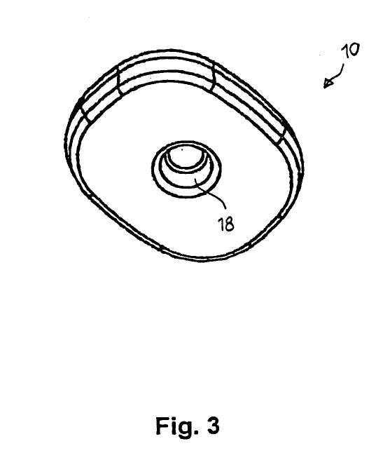

FIG. 3 shows a perspective view of the container from below.

FIG. 1 shows a top view of an embodiment of a plastic container 10 of the invention. The plastic container is made of polyethylene and is produced as a single piece by blow molding. It is suitable for collecting rainwater in volumes of 2,000 to 4,000 liters, and preferably 3,000 liters. Typical dimensions are 3 m long×2.5 m wide×0.6 m high for a 3,000-liter capacity. The container 10 has a stone-design structure on the outside surface 12, so that it fits in with the garden in a pleasing way.

FIG. 2 shows a schematic cross section of the container 10. The essentially flat underside 14 of the container 10 rests on the ground. A trough 16 comprises most of the upper side. This trough 16 can reach a trough depth, starting from its upper rim, of almost 50% of the overall height of the tank 10. Typically, the depth of the trough is about 30-45%, and preferably 40%, of the height of the container 10. To increase the bearing capacity of the trough 16, a recess 18 is formed in the underside 14. The almost cylindrical sidewall 20 of the recess 18 extends up to the trough 16 in its central region and supports the trough 16 there. This is necessary, because the trough 16 serves as a bearing surface that is intended to support, for example, the several hundred liters of water of a garden pond or, in other embodiments, the soil of a flower bed or the weight of a rock garden.

The rainwater is collected in the cavity 22. It enters the cavity 22 through a filling hole in the upper side (not shown), for example, via a connection to a rain gutter. In addition, a taphole (not shown) for the collected rainwater is provided, through which the collected rainwater can be removed by means with which the expert is already familiar. A closable opening 24 is provided between the cavity 22 and the upper wall of the container, which is formed as the trough 16. When the trough 16 is used to hold a garden pond, water can be distributed through this opening 24. For example, water can be conveyed from the cavity 22 into the space within the trough 16, or water can be conveyed from the trough 16 to the cavity 22. If the trough 16 serves as a bearing surface for a garden pond, the water content of the pond can also serve as a usable volume of water. The upper rim of the trough 16 is provided with an overflow hole 26, through which the volume of the trough 16 can be filled by water from the cavity 22.

FIG. 3 shows a perspective view of the container 10 from below. The drawing shows the stable recess 18, whose sidewall acts as a support element for the upper wall of the container, which is designed as a load-bearing trough.

1. Plastic container for collecting rainwater, which has an underside (14) that rests on the ground, a cavity (22) for collecting the rainwater, and an upper side, wherein the essentially closed upper side has the shape of a trough (16), which is designed as a bearing surface, wherein the underside (14) has a recess (18), whose sidewall (20) extends up to the trough (16) and supports it.

2. Container in accordance with claim 1, wherein the upper region of the trough (16) has an overflow hole (26) to the cavity (22).

3. Container in accordance with claim 1, wherein a closable opening (24) is located between the cavity (22) and the lower region of the trough (16).

4. Container in accordance with claim 1, wherein a filling hole for filling the cavity with rainwater and a taphole for removing rainwater from the cavity are provided.

5. Container in accordance with claim 1, wherein it is produced as a single piece by blow molding.

6. Container in accordance with claim 1, wherein the plastic material is polyethylene.

7. Container in accordance with claim 1, wherein the trough (16) forms the bottom of a garden pond.

8. Container in accordance with any of the preceding claims, characterized by the fact that the trough (16) supports a flower bed or a rock garden.

9. Container in accordance with claim 1, wherein the cavity has a volume of 2,000 to 4,000 liters and preferably 3,000 liters.
